(19) United States
(12) Patent Application Publication
(10) Pub. No.: US 2006/0178814 A1
(43) Pub. Date: Aug. 10, 2006

(54) Method of, and system for, assessing the nature of movement of articles along a path of movement

(76) Inventor: Timothy J. Everett, Pulborough (GB)

Correspondence Address: PHILIPS INTELLECTUAL PROPERTY & STANDARDS, P.O. BOX 3001, BRIARCLIFF MANOR, NY, 10510, US

(21) Appl. No.: 10/567,041

(22) PCT Filed: Jul. 30, 2004
(86) PCT No.: PCT/IB04/02584

§ 371 Date: Feb. 2, 2006

(30) Foreign Application Priority Data
Aug. 7, 2003 (GB) 0318480.1

(51) Int. Cl. G01C 21/36

(52) U.S. Cl. 701/205; 701/200

(57) ABSTRACT

A method of assessing the movement of articles, such as motor vehicles, comprises first articles (V1) moving along a first path of movement transmitting signals representative of their respective speed and their identity. At least one second article (V2) moving along a second, opposite path of movement receives the signals from a plurality of the first articles, analyses the signals to select only the wanted signals, determines the nature of movement of the articles from speed data in the wanted signals, compiles a report containing the nature of movement of the articles together with an indication of the distance to the location at which signals from the first articles were received, and transmits the report. A third article (V3) travelling along the first path of movement behind the first articles receives the report from the second article, analyses the report and, if appropriate, displays the determined nature of movement of the first articles with a distance indicator to an occupant of the third vehicle. As the second article travels further and further from the site of the determination of the nature of the movement of the first articles it updates the distance indicator and after a predetermined distance of travel from the site or elapse of time, the second article discontinues transmission of the particular traffic report.

The present invention relates to a method of, and system for, assessing the nature of movement of articles along a path of movement. The present invention has particular, but not exclusive, application to assessing the nature of movement of vehicles along a highway and alerting drivers of vehicles to potential traffic problems ahead of them on their journeys.

For convenience of description the present invention will be described with reference to vehicles moving along a highway but it is to be understood that the teachings of the present invention can be applied to other articles having transceiving means and means for monitoring a relevant performance characteristic of the article, the articles being self propelled or supplied onto a conveyor.

Currently there are several methods of informing drivers of actual traffic problems on roads. For example many local broadcast radio stations will transmit periodically and/or on a need basis in an emergency situation, reports of traffic problems in their local areas. Information contained in these reports is frequently sourced from cameras in traffic control rooms, the police and drivers telephoning reporters at the radio station. Whilst these broadcasts can be very helpful they generally report problems once they have occurred which means that for drivers close to the problem it is too late for them to divert from their route. Also sometimes reports of traffic problems are being broadcast long after the problem has been resolved thereby causing drivers to follow diversionary route unnecessarily. Providing the vehicle is equipped with a broadcast radio having the facility to receive the traffic broadcast, this method is free at the point of delivery.

Another known system in current use in the UK is generally known as “Trafficmaster” and is supported by the company known as Trafficmaster Developments Limited. Trafficmaster is a private system insofar that users have to buy dedicated receiving equipment and pay annual fees to benefit from the services provided. This system relies on monitoring traffic flows using a variety of detectors which may be mounted on the roadside, lamp standards, bridges and the like. Information from these detectors is transmitted to one or more control centres which by way of radio beacons relay information directly to those vehicles authorised to received it.

US Patent Application Publication US 2003/0043059A1 discloses a vehicle warning system which avoids the need for infrastructure for detecting conditions which will have a bearing on detecting traffic problems. The system comprises detection and diagnostic equipment, vehicle position location equipment and a radio transceiver installed in vehicles. Any traffic problems diagnosed together with the geographical position of the vehicle are transmitted by radio to another location, for example a communications centre. The communications centre relays the received information to users by one or more of the following: satellite links to other vehicles, TV stations, radio stations, road crews and/or active highway signs. The detection equipment includes means for monitoring vehicle operating parameters such as wheel speed, brake switch activation, vehicle speed, acceleration, deceleration, wheel axle torque, yaw rate, steering wheel angle, wheel slippage and so forth. Additionally a temperature sensor may be included for detecting icing conditions. A programmed computer is coupled to the detector(s) and diagnoses from the monitored parameter(s) the most likely traffic problem. This conclusion is combined with information about the vehicle position derived from Global Positioning System (GPS) or similar satellite navigational signals or roadside beacons and the result is transmitted to the communications centre. Preferably the communications centre is controlled to communicate traffic problem information to vehicles most likely to be affected, for example traffic heading towards a probable traffic jam rather than to traffic heading away from the area of the traffic jam. Drawbacks to this cited system are that it still requires a lot of installed infrastructure equipment for relaying the traffic reports and also it relies on traffic reports diagnosed and generated by equipment in individual vehicles which could- under certain circumstances be incorrect thereby causing complications for certain users.

An object of the present invention is to be able to assess reliably the occurrence of problems, such as congestion in the movement of articles, in a way which does not require large quantities of installed infrastructure.

According to a first aspect of the present invention there is provided a method of assessing the movement of articles moving along opposite paths of movement, each of the articles having transceiving means and means for monitoring a performance characteristic of the article, the method comprising each of the articles moving along a first of the paths of movement transmitting data derived from the monitored performance characteristic, and at least one article moving along a second of the paths of movement receiving transmissions from the articles moving along the first of the paths of movement, making an assessment of the nature of movement of the articles along the first path of movement from the data derived from the monitored performance characteristic, producing a report containing the assessment and transmitting the report for reception by subsequent articles moving along the first of the paths of movement.

The first aspect of the present invention provides a method of assessing the movement of vehicles, comprising first vehicles moving along a first path of movement transmitting signals representative of their respective speed and their identity, at least one second vehicle heading in a second, opposite path of movement receiving the signals from a plurality of the first vehicles, analysing the signals, assessing the nature of movement of the first vehicles along the first path of movement, compiling a report containing the assessment of the nature of movement of the first vehicles together with an indication of the distance to the location at which the signals from the first vehicles were received, and transmitting the report for reception by a third vehicle travelling along the first path of movement behind the first vehicles.

According to a second aspect of the present invention there is provided a system for assessing the movement of vehicles travelling along opposite paths of movement, each vehicle having a transceiver, means for monitoring the speed of the vehicle, means for compiling a speed report including vehicle identifying indicia for transmission by the transceiver, means for receiving a plurality of speed reports from in-range vehicles travelling along an opposite path of movement to that of the receiving vehicle, means for analysing the signals, means for assessing the nature of movement of the vehicles transmitting the received speed reports, means for compiling a traffic report containing the assessment of the nature of movement of the vehicles transmitting the speed reports together with an indication of the distance to the locality at which the speed signals were transmitted, and transmitting the traffic report for reception by a vehicle travelling along the said opposite path of movement.

According to a third aspect of the invention there is provided an apparatus for use in a vehicle and for assessing the movement of vehicles travelling along opposite paths of movement, the apparatus comprising a transceiver, means for monitoring the speed of the vehicle, means for compiling a speed report including vehicle identifying indicia for transmission by the transceiver, means for receiving a plurality of speed reports from in-range vehicles travelling along an opposite path of movement to that of the receiving vehicle, means for analysing the received signal reports, means for assessing the nature of movement of the vehicles transmitting the received speed reports, means for compiling a traffic report containing the assessment of the nature of movement of the vehicles transmitting the speed reports together with an indication of the distance to the locality at which the speed signals were transmitted, and means for transmitting the traffic report for reception by a vehicle (V3) travelling along the said opposite path of movement.

In its most elementary implementation the method of, and system for, assessing the nature of movement of articles, such as vehicles, in accordance with the present invention does not require any installed infrastructure as all the various operation are performed by vehicle mounted equipment. The reliability of the assessment reports is enhanced because the at least one second vehicle receives a cluster of speed reports from a small area and by statistical analysis can reject any which are not relevant because for example they are transmitted by vehicles going in the same direction as the second vehicle, one vehicle is overtaking another or a vehicle is leaving the highway along which the first vehicles are driving. Another beneficial feature of the method and system in accordance with the present invention is that it attempts to diagnose a traffic problem as it is developing and is able to give a prompt warning to drivers heading for what is perceived as a traffic problem. Conversely if the traffic problem is resolved or does not develop fully this can be reported to drivers in other traffic reports so that for example they know that there is no necessity to divert from their chosen route.

The present invention will now be described, by way of example, with reference to the accompanying drawings, wherein:

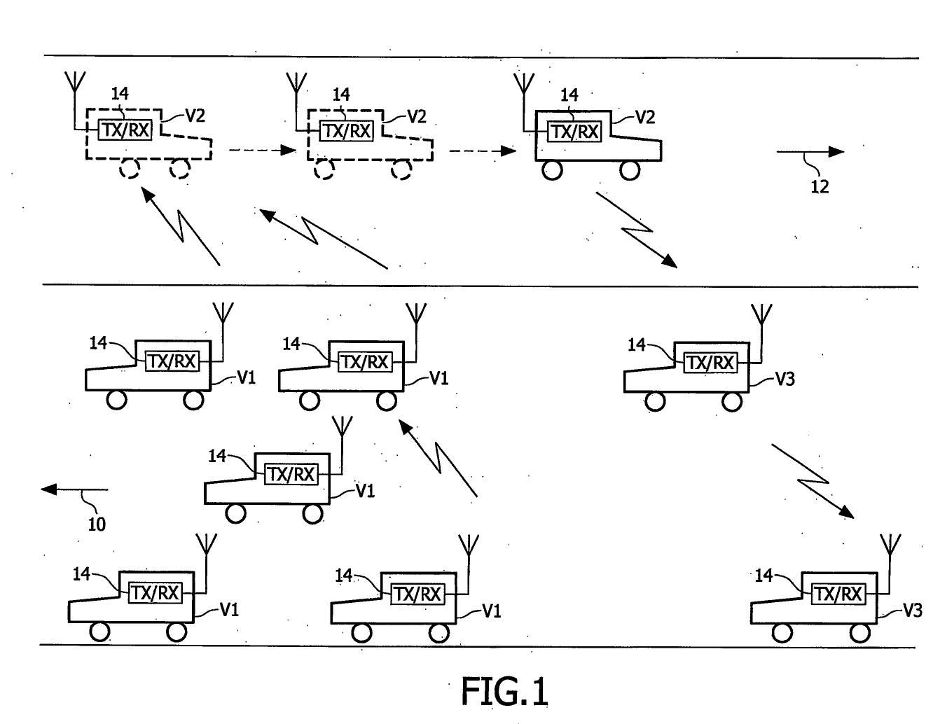

FIG. 1 is a diagram illustrating an elementary implementation of the system made in accordance with the present invention,

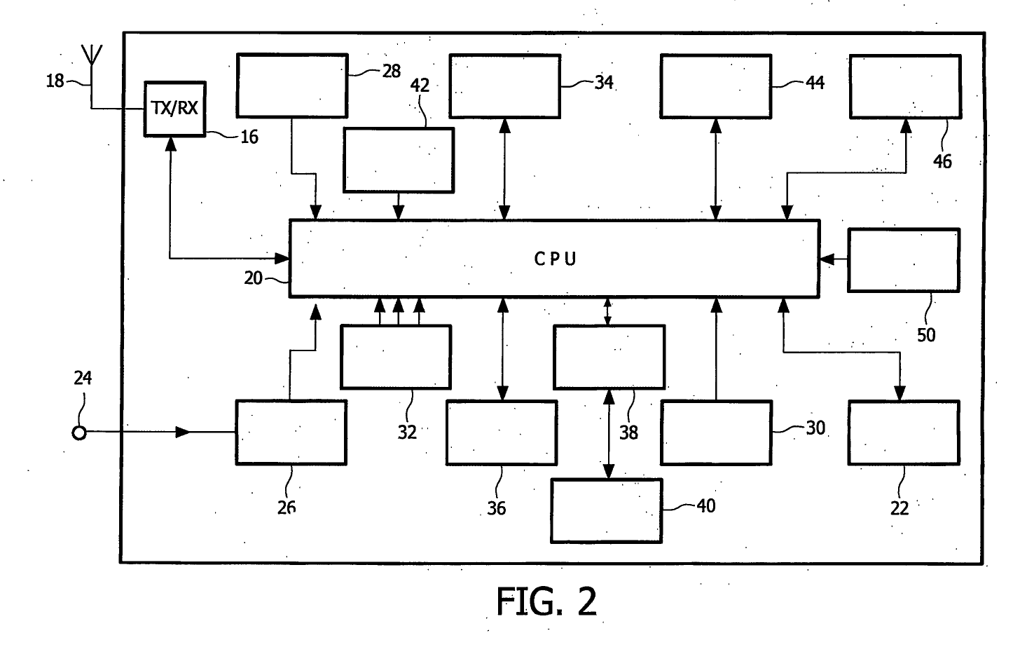

FIG. 2 is a block schematic diagram of the equipment installed in a vehicle,

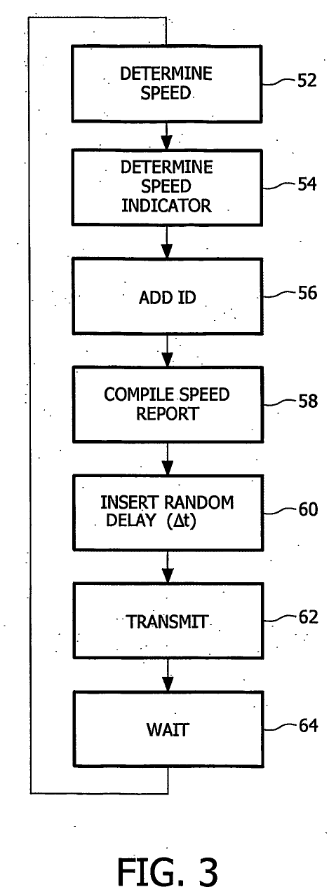

FIG. 3 is a flow chart of the process carried out by the first vehicle,

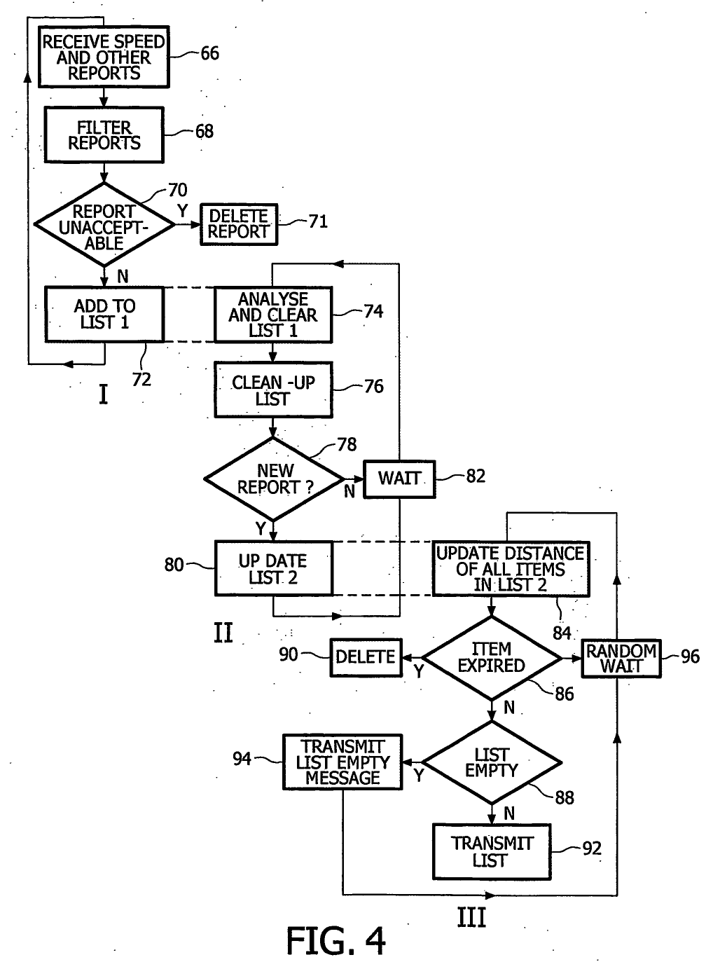

FIG. 4 shows flow charts of several tasks carried out by the second vehicle in determining if a traffic problem exists,

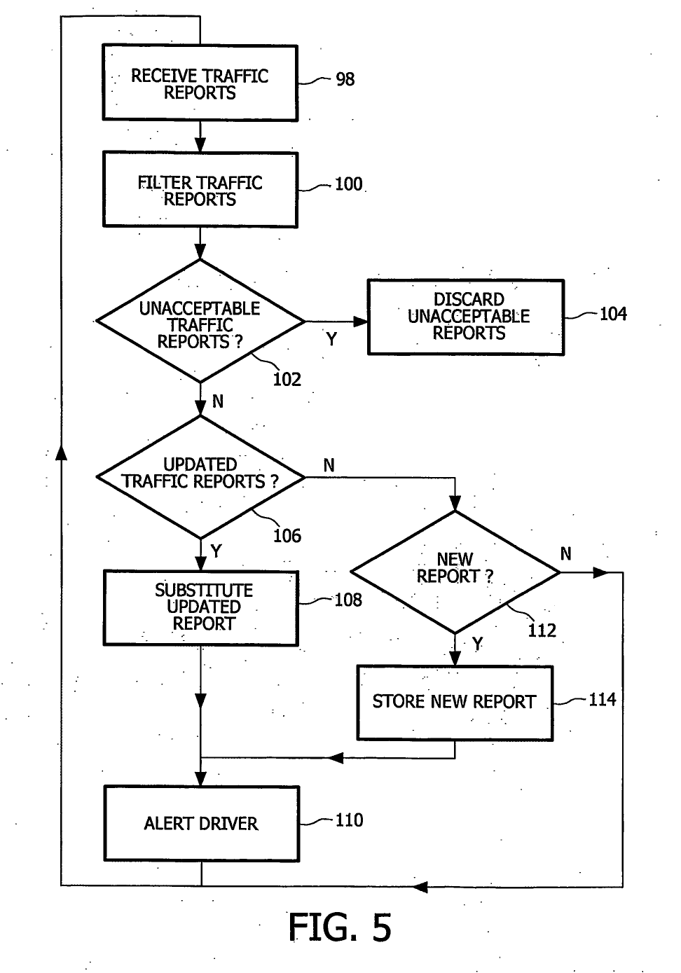

FIG. 5 is a flow chart of the processes carried out by a third vehicle receiving a traffic report, and

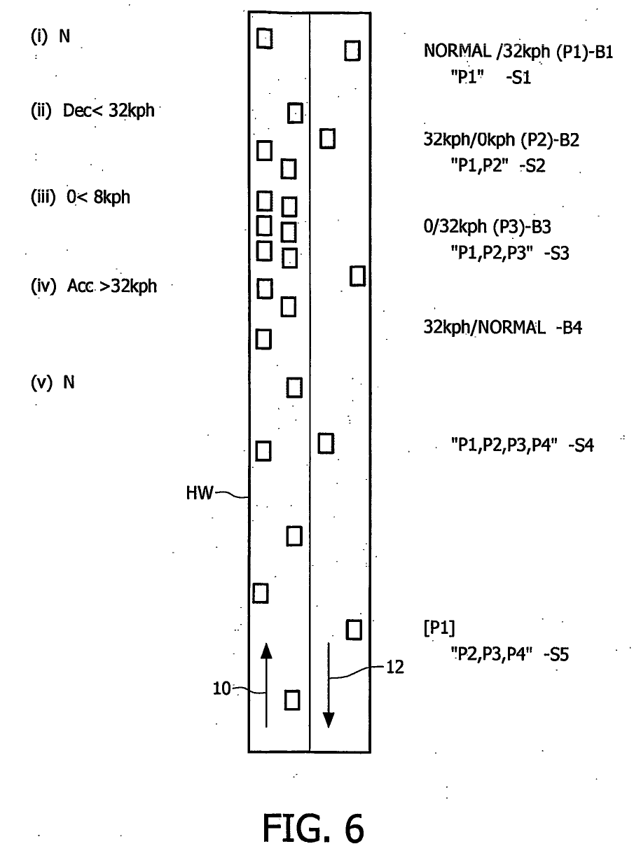

FIG. 6 is a diagram illustrating an embodiment of the method in accordance with the present invention.

In the drawings the same reference numerals have been used to indicate corresponding features.

Referring to FIG. 1 which shows a highway on which vehicles travel on the left hand side of the road. In order to facilitate an understanding of the present invention, the traffic, that is the vehicles referenced V1 and V3, proceeding from right to left will be described as proceeding along a first path of movement 10 and the traffic, that is the vehicle(s) V2, proceeding left to right will be described as proceeding along a second path of movement 12. All the vehicles V1, V2 and V3 are equipped with the same equipment 14 which includes means for determining the speed of the vehicle and a radio transceiver. Each vehicle transmits, say periodically, an indication of its own speed together with an identifier, which may be a code sufficient to distinguish that vehicle from other vehicles, and traffic reports, which may make use of information derived from other vehicles travelling along the opposite path of movement, and receives speed signals and traffic reports from other in-range vehicles. The equipment 14 will be described in greater detail with reference to FIG. 2.

Reverting to FIG. 1, it will be assumed that the vehicles V1 are decelerating and in so doing the speed indication in their respective signals reflect this change in road behaviour which may be due to the effects of congestion ahead. The vehicle V2 proceeding in the second direction 12 receives a plurality of radio transmissions. In processing the received signals it filters out, as described below, the clearly unwanted signals such as those due to vehicles travelling in the second direction 12 and single signals from a vehicle or vehicles travelling in the first direction 10 but may have left the highway. It examines the retained signals and decides that they indicate that the vehicles V1 have slowed sufficiently that this may be due to congestion.

The vehicle V2 compiles a traffic report giving an assessment of the reduced speed of the vehicles V1, optionally, the possible cause of any change, and a time and/or distance indication. The vehicle V2 transmits the report. Any in-range vehicle, especially the vehicles V3, receiving the traffic report is made aware that the traffic ahead along the first path of movement 10 is slowing down. The driver of a vehicle V3 has the option of taking what action he/she deems appropriate.

If subsequent reports from the vehicle(s) V2 indicate that the vehicles V1 have slowed further, the drivers of the vehicles V3 may assume that a traffic jam exists ahead and slow down or leave the highway, or that the vehicles V1 have accelerated, the drivers of the vehicles V3 may assume that no cautionary or diversionary action is necessary. Various refinements to this basic method will be described later.

Referring to FIG. 2 the equipment 14 comprises a transceiver 16 coupled to an antenna 18 for propagating signals, that is speed reports relating to the speed of the vehicle in which the equipment is being carried and traffic reports generated by the equipment, and for receiving signals, that is speed reports from other vehicles and traffic reports generated by other vehicles. A central processing unit (CPU) 20 operating in accordance with program software stored in a ROM 22 processes the various signals a required. In order to facilitate understanding of the operation of the CPU 20 a number of off-chip circuit elements have been shown connected to the CPU 20 but it is realised that some or all of these elements could be integrated in the CPU or the functions implemented in software.

Input 24 to the equipment 14 carries a speed signal which is held in a buffer memory 26 having an output coupled to the CPU 20. This signal is used by the CPU 20 to transmit a speed signal. In one form the message includes the actual speed together the vehicle's registration identification and this message is transmitted at regular intervals. However since such a message could be misused, and to provide the driver with a level of anonymity, some or all of the following modifications can be adopted by the CPU 20. A random delay (or delta) generator 28 may be coupled to the CPU 20 in order to vary the broadcast interval. This is regarded as being potentially important in preventing a recipient of a traffic report message, which may contain a distance and/or timing indicator, using this information to estimate the vehicle's V2 speed. As the actual identity of the vehicle is not relevant to the signal processing and any identity provided is used only to filter out multiple messages from the same vehicle then a pseudo random identity code generator 30 may be coupled to the CPU 20 to generate a contemporaneous ID having a life of say 10 minutes after which it is changed. Finally it is not critical that the actual speed be transmitted but only an indication of the speed. A store 32 containing a number of speed threshold values is coupled to the CPU 20. An example of the threshold values is 8 kph, 16 kph and 32 kph so that the CPU 20 is able to compare the speed value held in the buffer memory 26 with these threshold values and produce one of four indications, namely, (a) less then 8 kph, (b) between 8 and 16 kph, (c) between 16 and 32 kph, and (d) greater than 32 kph. For convenience in filtering speed reports and traffic reports it is desirable that each type of report has indicia or header indicative of the type of message being transmitted.

In the case of generating a traffic report, the equipment 14 receives a plurality of speed and traffic reports which are stored in a buffer store 34. The CPU 20 separates the desired speed reports and stores them in a speed report store 36. A traffic report generator 38 examines the speed reports based on its own current speed and the IDs contained in the message. The purpose of this is to determine if there is a change of speed occurring on the opposite carriageway. Messages from vehicles travelling in the same direction can be removed based on repetition of the ID and having speed values in the same range as the receiving vehicle, that is vehicle V2 in FIG. 1. Speed messages that appear only once are assumed to come from vehicles travelling in the opposite direction but there are times when this assumption is invalid such as when the receiving vehicle is overtaking or being overtaken or traffic is stationary in both directions. The overtaking/being overtaken situations are regarded as being relatively infrequent compared to the number of messages coming from vehicles on the carriageway. In the case of stationary traffic in both directions, there would be an obvious lack of speed messages from vehicles moving at speed.

Using what the CPU regards as valid messages, an assessment that there is a change of speed on the other carriageway is done statistically based on the percentage of messages received indicating that the change is occurring. This is marked as a problem and is added to the list of traffic reports held in a store 40. These traffic reports transmitted at suitable intervals. Each of these traffic reports includes the following information (i) nature of change, for example speed change less than 8 kph/between 8 and 32 kph, (ii) distance or updated distance (since the vehicle is moving away from the problem) to the problem as computed by computing element 42 using knowledge of the speed of the vehicle and the time elapsed since the first transmission of the particular traffic problem report, (iii) ID of the reporting vehicle.

The validity of a respective traffic report diminishes the further the vehicle V2 has travelled from the location of the perceived problem so each traffic report is given a lifetime after which it will be removed from the list. The lifetime can be based on real time and/or distance from the problem.

Travel reports received from other vehicles are held in a buffer store 44 and are filtered by a traffic report filtering stage 46 in order to eliminate travel reports from vehicles travelling in the same direction as the receiving vehicle. This can be done by comparing a received report with the reports which the receiving vehicle is holding in its store 40 for transmission and the IDs attached to the reports. This approach does not exclude erroneous reports transmitted by vehicles just joining the highway along which the receiving vehicle is travelling but the next following filtering will do so. Finally a statistical analysis is carried out to check if there is a good agreement of the received traffic problem reports. Thereafter the results can be displayed to an occupant of the vehicle using a visual display unit and/or or an auditory warning unit.

Optionally a vehicle location device 50, such as a GPS receiver, could be coupled to the CPU so that exact location of a perceived traffic problem (instead of an estimated distance) can be given.

FIG. 3 is a flow chart of a vehicle V1 (FIG. 1) producing a speed report. Block 52 relates to the equipment 14 determining the speed of the vehicle. Block 54 relates to selecting a speed indicator by comparing the speed against the pre-stored threshold values and producing an indicator representative of the speed range. Block 56 relates to generating a pseudo-random ID. Block 58 relates to the apparatus compiling a speed report which includes the speed indicator and the ID. Block 60 relates to inserting a random delta delay (At). Block 62 relates to the speed report being transmitted. Finally block 64 relates to waiting for an arbitrary period of time before repeating the process.

FIG. 4 shows flow charts of the various tasks, referenced I, II and III, relating to operations carried-out by an oncoming vehicle V2. In the first task I, the block 66 relates to receiving a plurality of speed reports and traffic reports. In block 68 these reports are filtered. Block 70 relates to checking if a report is unacceptable for any of the reasons mentioned previously and if the answer is “Yes” (Y) then in block 71 it is deleted. If the answer in block 70 is “No” (N) then in block 72 the report is added to a list 1.

Task II commences with block 74 which relates to analysing and clearing list 1. Block 76 relates to cleaning-up list 1 by removing unwanted reports. Block 78 relates to checking if a report in list 1 is new. If it is new (Y) then in block 80 a list 2 is updated. Thereafter there is a wait signified by block 82 before the process step 74 takes place again. If in block 78 the report is not new (N) the flow chart proceeds to block 82.

Task III commences with block 84 which relates to updating the distance in all the items in the list 2. Block 86 relates to checking if an item in the list 2 has expired and if it has (Y) then in block 90 it is deleted. If it has not expired (N) then in block 88 a check is made to see if the list 2 is empty. If it is not (N) then in block 92 the list is transmitted. If the list is empty (Y) then in block 94 a “List empty” message is transmitted. A block 96 relating to a random wait couples the outputs of the blocks 92, 94 to the block 84.

FIG. 5 is a flow chart relating to a vehicle V3 (FIG. 1) receiving a series of traffic reports. Block 98 relates to the traffic reports being received. Block 100 relates to filtering the traffic reports. In block 102 a check is made to see if any of the traffic reports are unacceptable. If there are (Y) then in block 104 the traffic report is discarded. If a traffic report is acceptable (N) a check is made if the report has been updated and if it has (Y) then in block 108 an updated report is substituted. In block 110 the vehicle occupant is alerted visually or orally.

If the answer in block 106 is No (N) then in block 112 a check is made to see if the traffic report is new. If it is (Y) then in block 114 the new report is stored.

FIG. 6 illustrates an embodiment of the method in accordance with the present invention. The drawing shows a highway HW comprising two carriageways with traffic driving on the left. In the left hand carriageway the vehicles are travelling along the first path of movement 10 and in the right hand carriageway the vehicles are travelling along the second path of movement 12. On the left hand side of the highway the entries referenced (i) to (v) relate to traffic behaviour in the first direction and on the right hand side entries B1 to B4 relate to crossing of a predetermined speed boundary and entries S1 to S5 features affecting the traffic reports.

Beginning with entry (i) which relates to normal traffic flow (N). Slightly later in time the entry B1 relates to the crossing of the normal/32 kph boundary (P1). The vehicles V2 detecting this boundary crossing transmit a signal S1 including traffic report P1.

At entry (ii) the traffic is decelerating (Dec) and the speed is less than 32 kph. Slightly later the 32 kph/stationary boundary (P2) is crossed (entry B2). Signal S2 now comprises two traffic reports P1, P2.

At entry (iii) the traffic is slow or stationary, that is less than 8 kph. Slightly later the stationary/32 kph boundary (P3) is crossed-entry B2. Signal S3 now comprises three traffic reports P2, P2, P3.

At entry (iv) the traffic is accelerating (Acc) and the speed is greater than 32 kph. Slightly later the 32 kph/normal boundary (P4) is crossed.

At entry (v) the traffic is flowing normally (N). The signal S4 now comprises four traffic reports P1, P2, P3, P4.

After the elapse of a further period of time, traffic report P1 times out and is deleted. This leaves three remaining traffic reports P2, P3, P4 being transmitted (signal S5). If the traffic flow in the direction 10 remains normal then the traffic reports P2, P3, P4 will time out. There is a benefit in a “No traffic report” message being relayed just to confirm that everything is normal.

The description of the present invention has for the sake of clarity only described vehicles V1 travelling along the first path of movement 10 transmitting speed reports and vehicles V2 travelling along the second path of movement issuing traffic reports in response to analysing the speed reports. However since all the vehicles participating in the method have similar equipments 14 (FIG. 2) then simultaneously with the vehicles V2 issuing traffic reports about the nature of movement of the vehicles V1 along the first path of movement 10 (FIG. 1), the vehicles V1 will be doing the same about the nature of movement of the vehicles V2 along the second path of movement 12 (FIG. 2). In other words vehicles in the contraflow to the flow of vehicles in the direction of interest determine the nature of the flow of oncoming traffic and transmit reports for reception by vehicles further back in the direction of interest.

If a vehicle is equipped with a GPS system and in-car navigation system then they can be used to enhance the method in accordance with the present invention. Traffic reports issued by such vehicles could contain a precise location instead of a distance indication. This means that to ensure compatibility with traffic reports for use by vehicles not having GPS and in-car navigation systems the report structure would have to be extended to enable location data to be given. Additionally the traffic report, perhaps in its header should contain an indication that location data is available. Receivers of these traffic reports if also equipped with GPS/navigation system could use the system to display the traffic report graphically (over the navigation map) and to determine if the reported problem or event is in fact on the intended route.

Other refinements which could enhance the performance of the method in accordance with the present invention include adding some infrastructure features such as traffic jam detection systems coupled to roadside beacons that relay problem reports to passing vehicles.

Portable beacons, which could pretend to be oncoming vehicles under the control of the authorities, could generate traffic reports which influence the behaviour of vehicles, for example by transmitting reports on accidents, road closures and the like. Also they could be installed at roadworks to warn motorists of possible delays/danger ahead.

These refinements imply that the traffic reports could contain information on more than just speed changes. In fact there could be a problem type indicator, taking a range of values a subset of which is to do with speed changes.

Another option is the provision of vehicles generating “special” signals (not speed related) that in turn could generate problem reports in vehicles on the other carriageway to be passed onto the vehicles behind. These special signals could be automatically generated by the vehicle (perhaps weather changes) or be driver generated (danger ahead, for example an accident or some other hazard such as animals on the road). A variant of this option is a driver of a patrol vehicle becoming aware of a problem on the opposite carriageway and generating a warning which is transmitted in the form of a traffic report for reception by oncoming vehicles.

Ultimately the driver receiving the traffic reports has to decide for himself/herself as to their veracity and whether he/she has or needs to respond to them.

Other optional refinements include the use of directional antennas to limit the transmission and reception to the intended carriageway. Roadside display systems, using the same logic as mentioned above, but relaying the information to all vehicles. These displays could be static at locations leading up to known blackspots, or may be portable and placed anywhere where traffic problems are expected, such as holiday routes, sporting events, roadworks. Lastly, beacons to indicate the presence of a junction/adjacent road—could be used as an aid to filter out spurious problem reports.

In the present specification and claims the word “a” or “an” preceding an element does not exclude the presence of a plurality of such elements. Further, the word “comprising” does not exclude the presence of other elements or steps than those listed.

From reading the present disclosure, other modifications will be apparent to persons skilled in the art. Such modifications may involve other features which are already known in the design, manufacture and use of traffic assessment methods and systems and component parts therefor and which may be used instead of or in addition to features already described herein.

1. A method of assessing the movement of articles moving along opposite paths of movement, each of the articles having transceiving means (16) and means (20, 26) for monitoring a performance characteristic of the article, the method comprising each of the articles (V1) moving along a first (10) of the paths of movement transmitting data derived from the monitored performance characteristic, and at least one article (V2) moving along a second (12) of the paths of movement receiving transmissions from the articles moving along the first of the paths of movement, making an assessment of the nature of movement of the articles along the first path of movement from the data derived from the monitored performance characteristic, producing a report containing the assessment and transmitting the report for reception by subsequent articles (V3) moving along the first of the paths of movement.

2. A method as claimed in claim 1, characterised in that the articles are vehicles (V1, V2, V3) and in that the monitored performance characteristic is the speed of the respective vehicles.

3. A method of assessing the movement of vehicles, comprising first (V1) vehicles moving along a first path (10) of movement transmitting signals representative of their respective speed and their identity, at least one second vehicle (V2) moving along a second (12), opposite path of movement receiving the signals from a plurality of the first vehicles (V1), analysing the signals, assessing the nature of movement of the first vehicles along the first path of movement, compiling a report containing the assessment of the nature of movement of the first vehicles together with an indication of the distance to the location at which the signals from the first vehicles were received, and transmitting the report for reception by a third vehicle (V3) travelling along the first path of movement behind the first vehicles.

4. A method as claimed in claim 3, characterised by the third vehicle receiving the report from the second vehicle, analysing the report and, if relevant, displaying the nature of the traffic problem together with a distance indicator to an occupant of the third vehicle.

5. A method as claimed in claim 3, characterised in that the at least one second vehicle amends the distance indicator as a function of the time elapsed since the traffic report was compiled.

6. A method as claimed in claim 3, characterised in that the at least one second vehicle ceases to transmit a traffic report after the elapsed time exceeds a predetermined threshold value.

7. A method as claimed in claim 3, characterised in that the at least one second vehicle amends the distance indicator as a function of the distance travelled since the traffic report was compiled.

8. A method as claimed in claim 3, characterised in that the at least one second vehicle ceases to transmit a traffic report after the distance travelled exceeds a predetermined threshold value.

9. A method as claimed in claim 3, characterised in that the at least one second vehicle transmits a signal indicative of it not having any traffic reports to relay.

10. A system for assessing the movement of vehicles travelling along opposite paths of movement (10, 12), each vehicle having a transceiver (16), means (20, 26) for monitoring the speed of the vehicle, means (20) for compiling a speed report including vehicle identifying indicia for transmission by the transceiver, means (16) for receiving a plurality of speed reports from in-range vehicles travelling along an opposite path of movement to that of the receiving vehicle, means (38) for analysing the received speed reports, means (20) for assessing the nature of movement of the vehicles transmitting the received speed reports, means (38) for compiling a traffic report containing the assessment of the nature of movement of the vehicles transmitting the speed reports together with an indication of the distance to the locality at which the speed signals were transmitted, and means (16) for transmitting the traffic report for reception by a vehicle (V3) travelling along the said opposite path of movement.

11. An apparatus for use in a vehicle and for assessing the movement of vehicles travelling along opposite paths of movement (10,12), the apparatus comprising a transceiver (16), means (20, 26) for monitoring the speed of the vehicle, means (20) for compiling a speed report including vehicle identifying indicia for transmission by the transceiver, means (16) for receiving a plurality of speed reports from in-range vehicles travelling along an opposite path of movement to that of the receiving vehicle, means (38) for analysing the received signal reports, means (20) for assessing the nature of movement of the vehicles transmitting the received speed reports, means (38) for compiling a traffic report containing the assessment of the nature of movement of the vehicles transmitting the speed reports together with an indication of the distance to the locality at which the speed signals were transmitted, and means (16) for transmitting the traffic report for reception by a vehicle (V3) travelling along the said opposite path of movement.
